(19) United States
(12) Patent Application Publication
(10) Pub. No.: US 2026/0012865 A1
(43) Pub. Date: Jan. 8, 2026

(54) OPTIMIZING CELL RESELECTION IN NON-TERRESTRIAL NETWORK (NTN)-TERRESTRIAL NETWORK (TN) OVERLAPPING COVERAGE AREA

(71) Applicant: Samsung Electronics Co., Ltd., Suwon-si (KR)

(72) Inventors: Amit Anandrao DANGE, Bangalore (IN); . Nishant, Bangalore (IN); Vivek MURUGAIYAN, Bangalore (IN); Kailash Kumar JHA, Bangalore (IN)

(21) Appl. No.: 19/225,408

(22) Filed: Jun. 2, 2025

Related U.S. Application Data
(63) Continuation of application No. PCT/KR2025/007158, filed on May 27, 2025.

(30) Foreign Application Priority Data
Jul. 2, 2024 (IN) 202441050679
Dec. 16, 2024 (IN) 2024 41050679

(51) Int. Cl. H04W 36/08; H04W 36/00; H04W 84/06

(52) U.S. Cl. CPC H04W 36/08; H04W 36/0058; H04W 36/0061; H04W 84/06

(57) ABSTRACT

A method for cell selection/reselection in a non-terrestrial network (NTN)-terrestrial network (TN) overlapping coverage area within a communication network is provided. The method includes obtaining, by a user equipment (UE) from an NTN cell, TN area information of one or more neighbor TN areas, obtaining, by the UE from at least one TN cell, frequency information based on the obtained TN area information, determining, by the UE, at least one neighbor TN cell to perform cell selection/reselection measurements based on the obtained frequency information, and performing, by the UE, cell selection/reselection measurements of the at least one determined neighbor TN cell.

### CROSS-REFERENCE TO RELATED APPLICATION(S)

This application is a continuation application, claiming priority under 35 U.S.C. § 365(c), of an International application No. PCT/KR2025/007158, filed on May 27, 2025, which is based on and claims the benefit of an Indian provisional patent application number 202441050679, filed on Jul. 2, 2024, in the Indian Patent Office, and of an Indian complete patent application number 202441050679, filed on Dec. 16, 2024, in the Indian Patent Office, the disclosure of each of which is incorporated by reference herein in its entirety.

### TECHNICAL FIELD

The disclosure relates to telecommunication network system, non-terrestrial network (NTN) and terrestrial network (TN). More particularly, the disclosure relates to handling cell reselection in NTN-TN overlapping area.

### BACKGROUND ART

The advent of 3^{rd} generation partnership project (3GPP) Release 17 marked a significant milestone in the realm of mobile telecommunications by introducing the non-terrestrial network (NTN) feature. This innovation aimed to facilitate direct communication between smartphones and satellites, particularly in remote or difficult-to-reach areas, thereby enhancing service availability for users. The user equipment (UE) leveraging the NTN feature can achieve higher mobility and improved efficiency, empowering new user experiences and connecting more infrastructure.

Direct satellite communication via mobile devices presents a substantial opportunity for wireless service providers to enhance their offerings by incorporating non-terrestrial (satellite) communication services. This is especially pertinent in remote regions where terrestrial communication infrastructure has not been established. However, the integration of non-terrestrial and terrestrial communication services necessitates numerous advancements to ensure seamless operation and service continuity.

In response to these challenges, 3GPP Release 18 introduced enhancements for NTN-TN mobility with cell reselection to improve service continuity. A notable addition in Release 18 is the introduction of a new system information block (SIB) that provides TN coverage information within an NTN cell. This feature is intended to aid in the cell reselection process from an NTN cell to a TN cell.

Despite these advancements, the presence of overlapping cell reselection areas poses significant challenges. In such scenarios, there is a high likelihood of UEs frequently moving between TN-NTN, NTN-TN, or TN-TN cells. This frequent cell reselection in overlapping areas leads to several issues an increase in measurement activities, a rise in network signaling, higher power consumption, and unnecessary “ping-pong” effects between NTN and TN cells.

Therefore, there is a pressing need to address these disadvantages and other related shortcomings, or at the very least, to provide a viable alternative solution.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method for handling cell reselection in a non-terrestrial network (NTN-terrestrial network (TN) overlapping area.

Additional aspects will be set forth in part in the description which follows and, in part, will be apparent from the description, or be learned by practice of the presented embodiments.

In accordance with an aspect of the disclosure, a method for cell selection/reselection in NTN-TN overlapping coverage areas in a communication network is provided. The method includes obtaining, by a user equipment (UE) from an NTN cell, a TN area information of one or more neighbor TN areas, obtaining, by the UE from at least one TN cell, frequency information based on the obtained TN area information, determining, by the UE, at least one neighbor TN cell to perform cell selection/reselection measurements based on the obtained frequency information, and performing, by the UE, cell selection/reselection measurements of the at least one determined neighbor TN cell.

In accordance with another aspect of the disclosure, a user equipment (UE) or handling cell selection/reselection in a non-terrestrial network (NTN)-terrestrial network (TN) overlapping coverage areas in a communication network is provided. The UE includes memory, including one or more storage media, storing instructions and at least one processor communicatively coupled to the memory, wherein the instructions, when executed by the at least one processor individually or collectively, cause the UE to obtain TN area information of one or more neighbor TN areas from an NTN cell, obtain frequency information based on the obtained TN area information from at least one TN cell, determine at least one neighbor TN cell to perform cell selection/reselection measurements based on the obtained frequency information, and perform cell selection/reselection measurements of the at least one determined neighbor TN cell.

In accordance with another aspect of the disclosure, one or more non-transitory computer-readable storage media storing one or more computer programs including computer-executable instructions that, when executed by at least one processor of a user device individually or collectively, cause the user equipment (UE) to perform operations are provided. The operations include obtaining terrestrial network (TN) area information of one or more neighbor TN areas from a non-terrestrial network (NTN) cell, obtaining frequency information based on the obtained TN area information from at least one TN cell, determining at least one neighbor TN cell to perform cell selection/reselection measurements based on the obtained frequency information, and performing cell selection/reselection measurements of the at least one determined neighbor TN cell.

Other aspects, advantages, and salient features of the disclosure will become apparent to those skilled in the art from the following detailed description, which, taken in conjunction with the annexed drawings, discloses various embodiments of the disclosure.

### DESCRIPTION OF DRAWINGS

The above and other aspects, features, and advantages of certain embodiments of the disclosure will be more apparent from the following description taken in conjunction with the accompanying drawings, in which:

FIGS. 1A and 1B are a schematic diagram that illustrates a geostationary earth orbit (GEO) NTN cell coverage and TN coverage areas according to the related art;

FIG. 2 is a schematic diagram that illustrates a network topology of NTN-TN overlapping area during cell reselection according to the related art;

FIG. 3 is a schematic diagram that illustrates measurement of frequencies for cell reselection in NTN-TN overlapping area according to the related art;

FIG. 4 is a flow diagram that illustrates a method for performing cell reselection when UE camped on TN cell in NTN-TN overlapping area according to the related art;

FIG. 5 is a flow diagram that illustrates a method for performing cell reselection when UE camped on NTN cell in NTN-TN overlapping area according to the related art;

FIG. 6 is a block diagram that illustrates a UE for optimizing cell selection in NTN-TN overlapping area in a telecommunication network according to an embodiment of the disclosure;

FIG. 7 is a schematic diagram that illustrates a scenario of measuring frequencies of TN cells by UE during cell reselection in NTN-TN overlapping area according to an embodiment of the disclosure;

FIGS. 8A and 8B are a flow diagram that illustrates a method for optimizing cell selection in NTN-TN overlapping area in a telecommunication network according to various embodiment of the disclosure;

FIGS. 9A and 9B are a flow diagram that illustrates a method for optimizing cell selection in NTN-TN overlapping area in a telecommunication network according to various embodiments of the disclosure;

FIG. 10A is a schematic diagram that illustrates a scenario of measuring frequencies of neighboring TN cells for cell reselection according to an embodiment of the disclosure;

FIG. 10B is a schematic diagram that illustrates a scenario of remaining by UE on NTN cell based on user preference or power saving mode to avoid multiple cell reselection according to an embodiment of the disclosure;

FIG. 11 is a schematic diagram that illustrates a scenario of handling by UE to perform cell reselection in TN-NTN overlapping area while traveling in different path according to an embodiment of the disclosure; and

FIG. 12 is a flow diagram that illustrates a method for optimizing cell selection in NTN-TN overlapping area in a telecommunication network according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be understood at the outset that although illustrative implementations of the embodiments of the disclosure are illustrated below, the disclosure may be implemented using any number of techniques, whether currently known or in existence. The disclosure should in no way be limited to the illustrative implementations, drawings, and techniques illustrated below, including the design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments, to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching, and illuminating some embodiments and their specific features and elements and does not limit, restrict, or reduce the spirit and scope of the claims or their equivalents.

More specifically, any terms used herein, such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way, it may still be referred to as “one or more features” or “one or more elements” or “at least one feature” or “at least one element.” Furthermore, the use of the terms “one or more” or “at least one” feature or element does NOT preclude there being none of that feature or element, unless otherwise specified by limiting language, such as “there NEEDS to be one or more . . . ” or “one or more element is REQUIRED.”

Unless otherwise defined, all terms, and especially any technical and/or scientific terms, used herein may be taken to have the same meaning as commonly understood by one having ordinary skill in the art.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

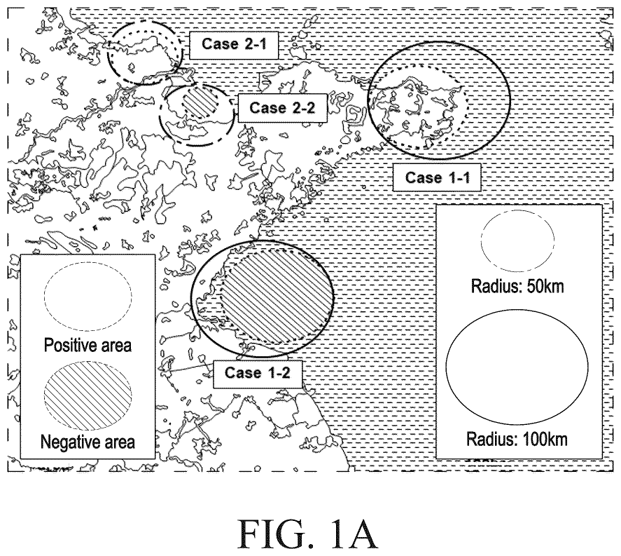

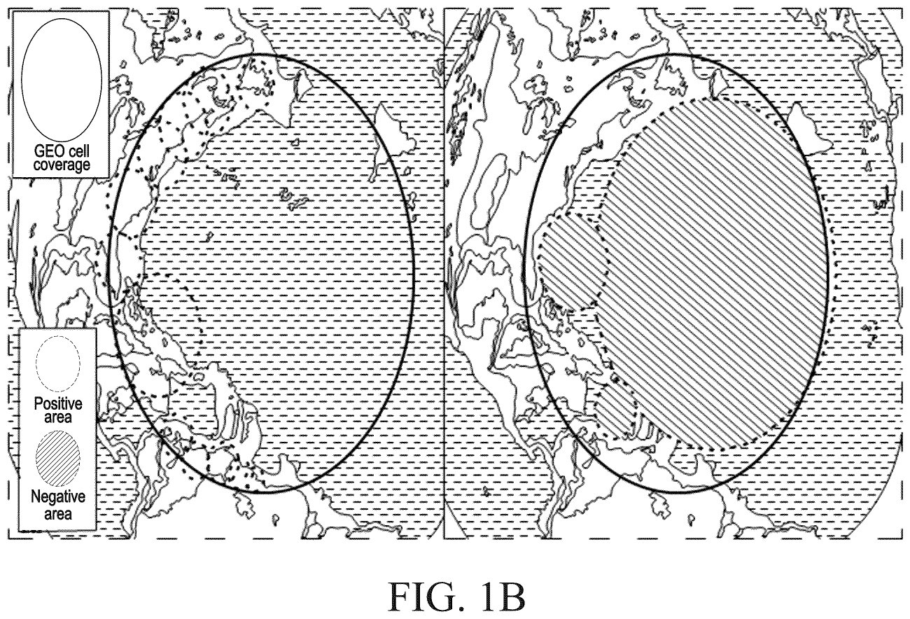

FIGS. 1A and 1B are a schematic diagram that illustrates a GEO NTN cell coverage and TN coverage areas according to the related art.

Referring to FIG. 1A, it indicates a GEO region where there is an overlapping between the NTN coverage area and TN coverage area. In addition, there are four marked areas indicated as Case 1-1, Case 1-2, Case 2-1, and Case 2-2. In all the four cases, the outer circle indicates the NTN coverage and the inner circle indicates the TN coverage. The NTN coverage area is larger than the TN coverage area. A device in the NTN coverage area may be served by satellites. Similarly, a device in the TN coverage area may be served by base stations. Consider, for example, in the Case 1-1 and Case 1-2, the NTN coverage area is up to 100 Km and the TN coverage area is up to 50 Km. Further, in the case 1-1 comprises a positive area, the overlapping area is a positive area, and in the case 1-2, the overlapping area is a negative area. Similarly, for example, in the case 2-1 and case 2-2, the NTN coverage area is up to 50 Km and the TN coverage area is up to 20 Km. Further, in the case 2-1, an overlapping area is a positive area, and in the case 2-2, the overlapping area is a negative area.

In prior art, a method and apparatus for measuring neighboring cells for cell reselection in a wireless communication system are disclosed. The method may include obtaining cell reselection condition information from a base station and moving from a first cell to a second cell based on the mobility of the terminal and the obtained cell reselection condition information. This method ensures that the terminal device may efficiently transition between cells, thereby maintaining a stable and reliable connection. The cell reselection process is required in scenarios where the terminal device is moving at high speeds, such as in vehicular or aerial applications, ensuring seamless connectivity and minimal service disruption.

In another prior art, a method and apparatus for wireless communication are disclosed. The method may include the terminal device performing cell reselection in the NTN cell based on first assistance information associated with one or more distribution conditions of TN cells in the NTN cells, a sub-region in the NTN cell, the sub-region being related to a coverage angle of a network device corresponding to the NTN cell, and TN cells contained in the sub regions in the NTN cells. This approach allows for more precise and efficient cell reselection by considering the specific distribution and coverage characteristics of TN cells within the NTN cell. By leveraging this detailed assistance information, the terminal device may make more informed decisions about when and where to reselect cells, leading to improved overall network performance and user experience.

In yet another prior art, a method and device for performing ephemeris-based cell reselection in a satellite network are disclosed. The existing technique may include performing measurement of at least one neighbor cell based on the distance between the terminal and the reference location of the serving cell and the distance threshold value. Further, the method may include performing a cell reselection based on the measurements of at least one neighbor cell. This technique takes into account the relative positions and movements of the satellite and terminal device, allowing for more accurate and timely cell reselection decisions. By incorporating ephemeris data, the system may predict the future positions of satellites and adjust the cell reselection process accordingly, enhancing the reliability and efficiency of satellite-based communication networks.

The existing prior arts perform the cell measurements for all the frequencies that are included in the SIB 4/SIB 5 broadcast message, leading to unnecessary measurements and consuming more power of the UE. This inefficiency may be particularly problematic in scenarios where power consumption is a concern, such as in battery-operated devices or remote sensing applications. By optimizing the cell measurement process and reducing the number of unnecessary measurements, it is possible to extend the battery life of the UE and improve the overall efficiency of the communication system.

Referring to FIG. 1B, the outer circle indicates two GEO regions where the first geo region comprises an NTN coverage area and a plurality of TN coverage areas. The plurality of TN coverage areas is of the positive area. Similarly, for a second geo region, it comprises an NTN coverage area and a plurality of TN coverage areas where the TN coverage areas are of negative areas. This distinction between positive and negative areas in the TN coverage regions highlights the variability and complexity of the overlapping coverage areas in GEO regions. Understanding these nuances is required for optimizing network performance and ensuring seamless connectivity for devices operating within these regions.

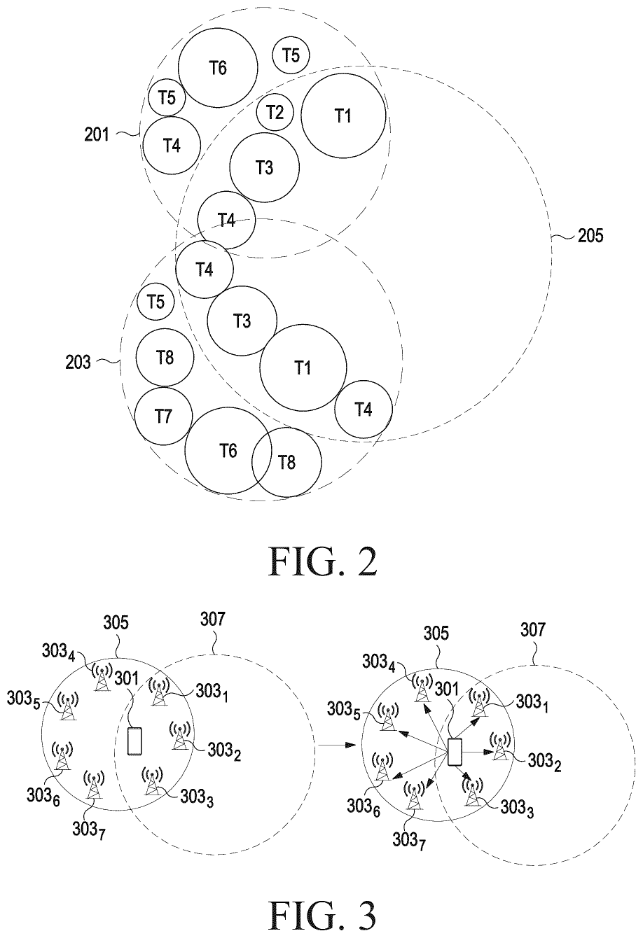

FIG. 2 is a schematic diagram that illustrates a network topology of NTN-TN overlapping area during cell reselection according to the related art.

Referring to FIG. 2, a first TN coverage area 201 comprises a plurality of TN cells T1, T2, T3, T4, T5, and T6. Similarly, a second TN coverage area 203 comprises a plurality of TN cells T1, T3, T4, T5, T6, T7, and T8. Additionally, there is an NTN coverage area 205 that serves a plurality of NTN cells T1, T2, T3, and T4. For example, consider the frequencies associated with TN areas T1 to T7 included in the TN SIB4/SIB 5 message as shown in Table 1.

TABLE 1

| SIB4 & SIB5 freq in TN cell | Cell |
|---|---|
| T1 | PCI 101 |
| T1 | PCI 89 |
| T2 | PCI 90 |
| T3 | PCI 102 |
| T5 | PCI 201 |
| T4 | PCI 303 |
| T4 | PCI 90 |
| T6 | PCI 102 |
| T6 | PCI 303 |
| T7 | PCI 90 |
| T7 | PCI 102 |

For example, consider the frequencies associated with TN areas T1 to T4 included in the NTN SIB4/SIB 5 message is as shown in below Table. 2:

TABLE 2

| TN area ID | SIB4 & SIB5 freq in NTN cell |
|---|---|
| Area ID 1 201 | T1 |
| | T1 |
| | T2 |
| | T3 |
| Area ID 2 203 | T5 |
| | T4 |

In the existing technique, while performing cell reselection in an overlapping area between the NTN coverage area 205 and the TN coverage areas 201, 203, the UE measures the frequencies of all the TN cells, including T1, T2, T3, T4, T5, T6, T7, and T8, present in the first TN coverage area 201 and the second TN coverage area 203 as shown in Table 3. Based on the frequency measurements, the UE may camp on to one of the T1, T2, T3, T4, T5, T6, T7, and T8 cells. However, in the existing technique, the UE might be in a stable cell like T2 but still performs continuous frequency measurements for T1, T5, T6, and T3. Hence, the frequency measurements for the TN cells performed by the UE lead to more power consumption and frequent reselections of cells. In addition, the multiple frequency measurements and frequent reselection are bound to happen in TN-NTN overlapping areas for the operators deploying NTN coverage.

TABLE 3

| TN area ID | Frequencies/Cell |
|---|---|
| Area ID 1 | T1/PCI 101 |
| | T1/PCI 89 |
| | T2/PCI 90 |
| | T3/PCI 102 |
| Area ID 2 | T5/PCI 201 |
| | T4/PCI 303 |
| No Area ID | T4/PCI 90 |
| | T6/PCI 102 |
| | T6/PCI 303 |
| | T7/PCI 90 |
| | T7/PCI 102 |

In the existing technique, during NTN deployment, NTN is preferred in areas where TN coverage is not available to fill the gaps between TN coverage areas. Consequently, there are areas where NTN-TN coverage is overlapping. During NTN-TN overlapping coverage areas, the UE may perform cell switches between TN-NTN, NTN-TN, or TN-TN cells, e.g., reselection is observed in such network topologies to maintain service continuity. Further, in 3GPP release 18, NTN-TN mobility with cell reselection enhancement for service continuity became a study item to provide smooth mobility between NTN-TN networks. It is necessary to provide TN coverage-related information pertaining to the current NTN cell coverage when the UE is camped on to the NTN network to perform smooth transitioning between NTN and TN networks.

The System Information Block 25 has been introduced in 3GPP TS 38331 V1800 to enhance NTN-TN reselection and provide the TN area coverage information when the UE is in the NTN network. Additionally, the TN coverage area associated with neighbor frequencies is broadcasted in SIB4/5. Further, if the UE is camped on an NTN cell based on SIB4/5, the UE reselect to a neighboring TN cell and vice versa in the overlapping coverage area. Similarly, if the UE is camped on a TN cell based on SIB4/5 frequencies, the UE reselects from one TN cell to another, hopping between multiple TN cells continues without any optimization in the TN-NTN overlapping area. The frequent reselection, although not required, would lead to increased measurements for reselection, rise in network signaling, power consumption, and unnecessary ping-pong between TN cells. Hence, the user experience in such overlapping NTN-TN areas is poor, and power consumption is higher.

FIG. 3 is a schematic diagram that illustrates the measurement of frequencies for cell reselection in an NTN-TN overlapping area according to the related art.

Referring to FIG. 3, consider a UE 301 present in an NTN-TN overlapping area that has both the TN coverage area 305 and NTN coverage area 307. Further, for performing the cell reselection, the UE 301 measures the frequencies of all the TN cells 3031, 3032, 3033, 3034, 3035, 3036, and 3037 present in the TN coverage area 305. However, the frequency measurement performed for all the TN cells by the UE 301 leads to unnecessary frequency measurements and consumes more power.

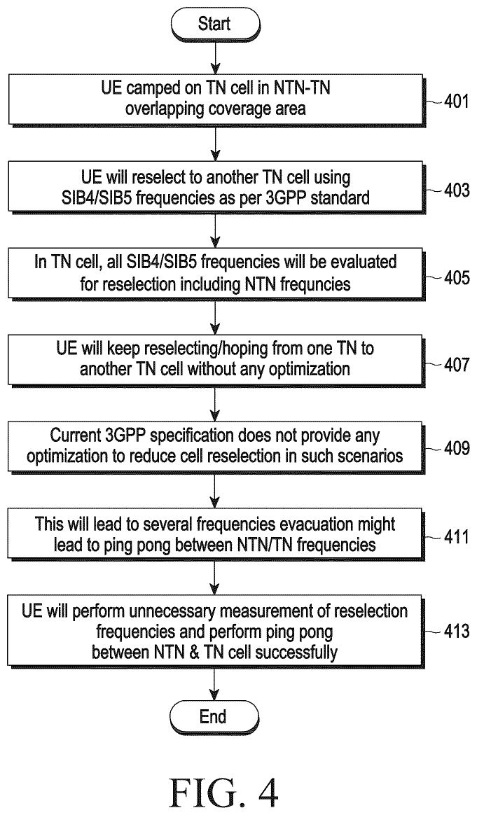

FIG. 4 is a flow diagram that illustrates a method for performing cell reselection when UE is camped on a TN cell in an NTN-TN overlapping area according to the related art.

Referring to FIG. 4, at operation 401, consider the UE 301 is camped on the TN cell in the NTN-TN overlapping coverage area.

At operation 403, the UE 301 reselects to another TN cell by measuring all the frequencies provided in the SIB 4/SIB 5 broadcast message received from the network.

At operation 405, further, the UE in the TN cell evaluates all SIB4/SIB 5 frequencies, including the NTN frequencies, for cell reselection. UE in the TN cell measures all neighboring cell frequencies present in the SIB4 and SIB5 broadcast message in order to select a target cell to reselect for service continuity. In addition, the UE performs reselection to the NTN cell based on whether the cell reselection criteria are satisfied.

At operation 407, the UE continues to reselect or hop from one TN cell to another TN cell without any optimization and by measuring all the frequencies included in the SIB 4/SIB 5 message.

At operation 409, the UE performs the continuous measurement of all frequencies included in SIB 4/SIB 5 and NTN cell frequencies without any optimization to reduce the cell reselection.

At operation 411, even though the UE is stable in the camped TN/NTN network, due to reselection, the UE moves between TN cells or TN to NTN cell & vice versa. In a stable network condition with multiple reselections (ping-pong), leads to higher power consumption due to new cells syncing/measurements, which further impacts the battery consumption.

At operation 413, the UE performs unnecessary measurement of neighboring frequencies for cell reselection, and the current 3GPP specification does not provide a mechanism to optimize reselection measurement in such a scenario. In addition, the UE observes poor user experience ping-pong between TN-TN, TN-NTN cells, and inferior battery performance of the device in overlapping NTN-TN overlapping areas.

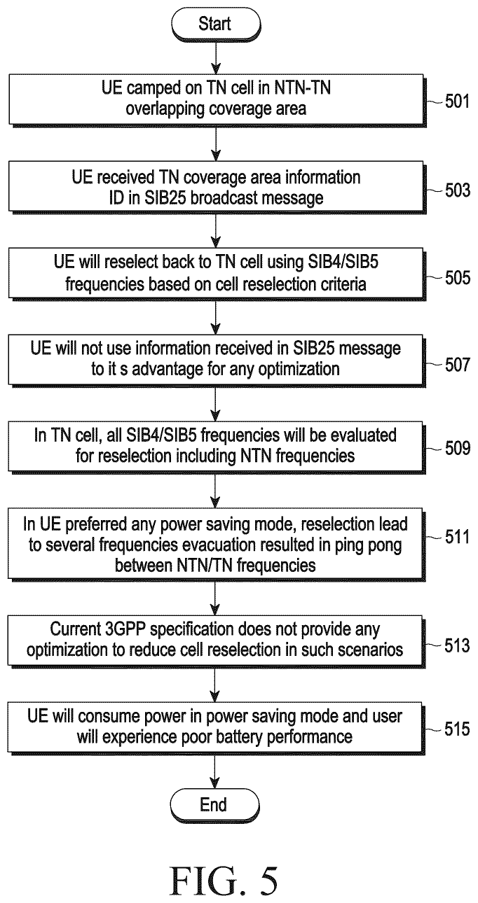

FIG. 5 is a flow diagram that illustrates a method for performing cell reselection when UE is camped on an NTN cell in an NTN-TN overlapping area according to the related art.

Referring to FIG. 5, at operation 501, camping by the UE is initially on a TN cell in the NTN-TN overlapping coverage area.

At operation 503, the UE receives TN area information in the SIB 25 broadcast message.

At operation 505, the UE reselects to another TN cell using SIB 4/SIB 5 frequencies as per the 3GPP standards. In the TN-NTN overlapping coverage area, in case of the UE camped on an NTN cell, the UE performs reselection to move from the NTN cell to the TN cell based on cell reselection criteria as per the current 3GPP specification.

At operation 507, the UE does not use the information received in the SIB25 message for optimizing the cell reselection process. As per release 18, while in the NTN cell, the UE receives TN area information as per SIB25 introduced. Further, the UE is aware of the neighboring TN frequencies coverage that is available for cell reselection/cell change while camped on the NTN cell. In addition, the TN area information contains multiple TN cells overlapping or on the border with NTN cells. Hence in such overlapping areas, the UE measures all reselection frequencies from SIB4 & SIB5 to reselect to the target cell (either TN or NTN). Hence, the UE does not use the TN area information to its advantage to remain on the NTN cell if the UE prefers it based on user preference & requirement. Instead, the UE performs the cell reselection process using SIB4/SIB5 frequencies associated with the TN area coverage identifier (ID) to move back to the TN cell.

At operation 509, the UE in the TN cell starts measuring TN and NTN frequencies for the further cell reselection process as per the current 3GPP standard.

At operation 511, when the UE has preferred any power-saving mode, the reselection process leads to several frequencies evacuation resulting in ping pong between NTN/TN frequencies. The ping pong between TN-NTN cells & within TN cells reselection increases the measurement of neighboring frequencies leading to an increase in power consumption of the UE.

At operation 513, the current reselection process by the UE in the NTN-TN overlapping coverage area does not provide any optimization to reduce cell reselection. The UE performs unnecessary measurement of neighboring frequencies for cell reselection and does not optimize reselection measurement.

At operation 515, as a result of unnecessary measurement of neighboring frequencies, the UE consumes power in power-saving mode and the user experiences poor battery performance. In addition, the UE observes poor user experience, ping pong between TN-TN, TN-NTN cells, and inferior battery performance of the device in overlapping NTN-TN overlapping areas.

Unlike the prior arts as described above, the embodiments in the proposed solution disclose a method and UE for optimizing cell selection in NTN-TN overlapping areas in a telecommunication network. The method may include receiving by a user equipment (UE) a TN area information of one or more neighbor TN areas when the UE is camped on an NTN cell. The TN area information comprises TN coverage area ID of the one or more neighbor TN areas, reference location of the one or more neighbor TN areas, a distance radius of the one or more neighbor TN areas, and frequency information associated with the TN area ID of the at least one neighbor TN cell. Further, the method may include storing by the UE the TN area information of the one or more neighbor TN areas. The method also may include determining by the UE at least one neighbor TN cell of one or more neighbor TN cells associated with a frequency to perform cell reselection measurements based on the frequency information associated with the TN area ID of the at least one neighbor TN cell. Further, the method may include determining by the UE whether to perform cell reselection measurements based on the TN area information, user preference, and current requirement of the UE. Additionally, the method may include performing by the UE cell reselection measurements of the at least one determined neighbor TN cell. In addition, the method may include skipping performing by the UE cell reselection measurements of the one or more neighbor TN cells.

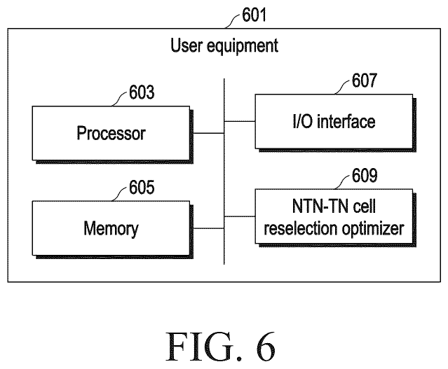

FIG. 6 is a block diagram that illustrates a UE for optimizing cell selection in NTN-TN overlapping area in a telecommunication network, according to an embodiment of the disclosure.

Referring to FIG. 6, a UE 601 may include a processor 603 (e.g., including processing circuitry), memory 605, an input/output (I/O) interface 607 and a NTN-TN cell reselection optimizer 223. The UE 601 may be a mobile device, laptop, desktop, smartphone, tablet and the like. Further, the processor 603 of the UE 601 communicates with the memory 605, the I/O interface 607 and a NTN-TN cell reselection optimizer 609. The processor 603 is configured to execute instructions stored in the memory 605 and to perform various processes. The processor 603 may include one or a plurality of processors, may be a general-purpose processor, such as a central processing unit (CPU), an application processor (AP), or the like, a graphics-only processing unit, such as a graphics processing unit (GPU), a visual processing unit (VPU), and/or an Artificial intelligence (AI) dedicated processor, such as a neural processing unit (NPU). Furthermore, the processor 603 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Further, the memory 605 of the UE 601 may include storage locations to be addressable through the processor 603. The memory 605 is not limited to a volatile memory and/or a non-volatile memory. Further, the memory 605 may include one or more computer-readable storage media. The memory 605 may include non-volatile storage elements. For example, non-volatile storage elements may include magnetic hard discs, optical discs, floppy discs, flash memories, or forms of electrically programmable ready only memories (EPROM) or electrically erasable and programmable ROM (EEPROM) memories. The memory 605 stores the TN area information of the one or more neighbor TN cells received in at least one of SIB4/SIB 5 broadcast message and SIB 25 broadcast message.

The I/O interface 607 transmits the information between the memory 605 and external peripheral devices. The peripheral devices are the input-output devices associated with the UE 601. The I/O interface 607 receives several information from the network apparatus. The several information received from the network apparatus may include but not limited to TN area information of the one or more neighbor TN cells in at least one of a SIB4/SIB 5 broadcast message and SIB 25 broadcast message.

The NTN-TN cell reselection optimizer 609 communicates with the I/O interface 607 and memory 605 for optimizing cell selection in NTN-TN overlapping areas in a telecommunication network. The NTN-TN cell reselection optimizer 609 receives TN area information of one or more neighboring TN areas when the UE is camped on an NTN cell. The TN area is broader geographic region covered by a terrestrial network. In addition, the TN area may include one or more TN cells. For example, the TN area may span or cover entire city, region or country. The TN area represents the overall service area within which the network operates. The TN area information comprises the TN coverage area ID of the one or more neighboring TN areas, the reference location of the one or more neighboring TN areas, a distance radius of the one or more neighboring TN areas, and frequency information associated with the TN area ID of at least one neighboring TN cell. Further, the NTN-TN cell reselection optimizer 609 stores the TN area information of the one or more neighboring TN areas.

Additionally, the NTN-TN cell reselection optimizer 609 determines at least one neighboring TN cell of the one or more neighboring TN cells associated with a frequency to perform cell reselection measurements based on the frequency information associated with the TN area ID of the at least one neighboring TN cell. This determination process involves analyzing the frequency bands and signal strengths of the neighboring TN cells to ensure optimal connectivity and performance for the UE. The NTN-TN cell reselection optimizer 609 also takes into account various parameters, such as signal quality, network load, and historical performance data to make an informed decision on which neighboring TN cell to select for reselection measurements.

Furthermore, the NTN-TN cell reselection optimizer 609 evaluates whether to perform cell reselection measurements based on the TN area information, user preferences, and the current requirements of the UE. This evaluation ensures that the reselection process is aligned with the user's needs and the operational context of the UE, such as its mobility pattern and data usage. If the conditions are met, the NTN-TNcell reselection optimizer 609 proceeds to perform cell reselection measurements of the at least one determined neighboring TN cell. Conversely, if the conditions are not favorable, the NTN-TN cell reselection optimizer 609 may decide to skip performing cell reselection measurements for one or more neighboring TN cells, thereby conserving the UE's resources and maintaining its current connectivity. This intelligent decision-making process enhances the overall efficiency and user experience in NTN-TN overlapping areas.

The proposed solution provides a method for handling cell selection in NTN-TN overlapping areas in a telecommunication network. In the proposed solution, the UE will utilize TN coverage area ID details broadcasted in SIB 25 to its advantage and optimize cell reselection frequencies by filtering frequencies of SIB4/SIB5 for cell reselection and use these frequencies for cell reselection in NTN-TN overlapping areas. Additionally, based on details captured (multiple cell reselection measurements required) and user preference, the UE may choose to remain on an NTN cell in an NTN-TN overlapping area. The proposed solution utilizes a method to move the UE to an NTN cell to acquire System Information Block 25 and store cell reselection frequencies associated with TN coverage area info ID in the NTN-TN overlapping area to perform seamless cell reselection among TN cells. Further, the UE will use stored cell reselection frequencies to filter among TN neighbor frequencies broadcasted in SIB 4/5 of serving TN cells based on TN coverage information from SIB 25 for subsequent TN-TN cell reselection while in the NTN-TN overlapping area to optimize cell reselection frequencies measurement. In addition, the UE will use its location and reference location of TN coverage area ID to determine which TN area ID the UE belongs to and perform cell reselection measurement for those frequencies belonging to the set TN coverage area ID. Further, the proposed solution helps the UE to remain on an NTN cell if the UE prefers power saving and is required to remain in service, which may be accommodated by the NTN cell to avoid unnecessary cell reselection measurement to reduce power consumption.

The proposed solution optimizes the cell reselection by selecting frequencies associated with the TN coverage area ID for cell reselection measurement to avoid unnecessary measurement and save power and time in the NTN-TN overlapping area. In addition, in the proposed solution, the UE remains in the NTN cell to save power consumption while the user preference power-saving mode is enabled in the UE. The proposed solution provides an enhanced user experience along with prolonged battery life. This optimization not only enhances the efficiency of the telecommunication network but also ensures that the UE operates in an energy-efficient manner, thereby extending the battery life of the device. This is particularly beneficial in scenarios where the UE is in a location with overlapping NTN and TN coverage, as it may intelligently manage its connectivity to maintain optimal performance without compromising on power efficiency.

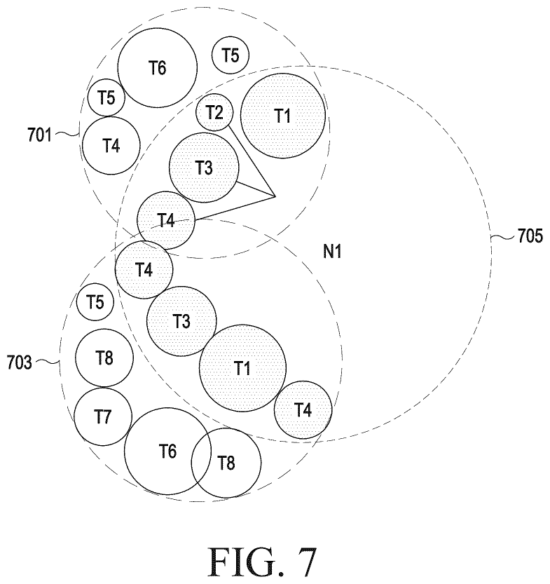

FIG. 7 is a schematic diagram that illustrates a scenario of measuring frequencies of TN cells by UE during cell reselection in an NTN-TN overlapping area according to an embodiment of the disclosure.

Referring to FIG. 7, consider two TN coverage areas: the first TN coverage area 701 and a second TN coverage area 703. The first TN coverage area 701 comprises a plurality of TN cells (T1, T2, T3, T4, T5, T6). Similarly, the second TN coverage area 703 comprises a plurality of TN cells (T1, T3, T4, T5, T6, T7, and T8). For example, consider the frequencies associated with TN areas T1 to T7 included in the TN SIB4/SIB 5 message as shown in the table below, Table 4.

TABLE 4

| SIB4 & SIB5 frequency in TN cell | Cell |
|---|---|
| T1 | PCI 101 |
| T1 | PCI 89 |
| T2 | PCI 90 |
| T3 | PCI 102 |
| T5 | PCI 201 |
| T4 | PCI 303 |
| T4 | PCI 90 |
| T6 | PCI 102 |
| T6 | PCI 303 |
| T7 | PCI 90 |
| T7 | PCI 102 |

Consider the UE 601 is present being served by the TN cell T2 of the first TN coverage area 701. Initially, the UE 601 detects the NTN coverage by receiving an SIB 19 broadcast message from the network. Upon detecting the NTN coverage, the UE 601 camps on the NTN cell in the NTN-TN overlapping coverage area. Upon camping on the NTN cell, the UE 601 receives the SIB 25 broadcast message and SIB 4/SIB 5 broadcast message from the network apparatus. The frequency information associated with the TN area ID in the SIB 4/SIB 5 broadcast message is shown in the table below, Table 5.

TABLE 5

| TN area ID | SIB4 & SIB5 frequency in NTN cell |
|---|---|
| Area ID 1 | T1 |
| | T1 |
| | T2 |
| | T3 |
| Area ID 2 | T5 |
| | T4 |

The UE 601 stores the TN area information included in the SIB 25 broadcast message. The TN area information included in the SIB 25 broadcast message comprises the TN coverage area ID of at least one TN cell, the TN reference location of at least one TN cell, and the TN distance radius of at least one TN cell. Further, the UE 601 determines the TN coverage area ID of the serving TN area based on the current location of the UE 601 and the reference location included in the SIB 25 broadcast message. Upon determining the TN coverage area ID, the UE 601 determines the frequencies associated with the TN coverage area ID using the SIB4/SIB 5 broadcast message. Further, the UE 601 performs the cell reselection measurement for those frequencies that belong to the TN coverage area ID. For example, as shown in Table 6 and FIG. 7, the UE 601 measures the frequencies particularly for the TN cells T1, T2, T3, and T4 of the first TN coverage area 701.

TABLE 6

| TN area ID | Frequencies /Cell |
|---|---|
| Area ID 1 | T1/PCI 101 |
| | T1/PCI 89 |
| | T2/PCI 90 |
| | T3/PCI 102 |
| Area ID 2 | T5/PCI 201 |
| | T4/PCI 303 |

This the proposed solution of performing necessary cell measurements significantly contributes to saving the power consumption of the UE 601. Additionally, in the proposed solution, during various power-saving modes and based on the UE's preference, the UE 601 may skip performing cell reselection and remain on the NTN cell (N1 cell 705). In NTN-TN overlapping areas, the UE 601 optimizes neighbor cell measurements and reduces frequent reselections. This optimization enhances the efficiency of the UE 601 and ensures a more stable and reliable connection by minimizing unnecessary transitions between cells. Consequently, this approach leads to an overall improvement in user experience, particularly in areas where NTN and TN coverages overlap.

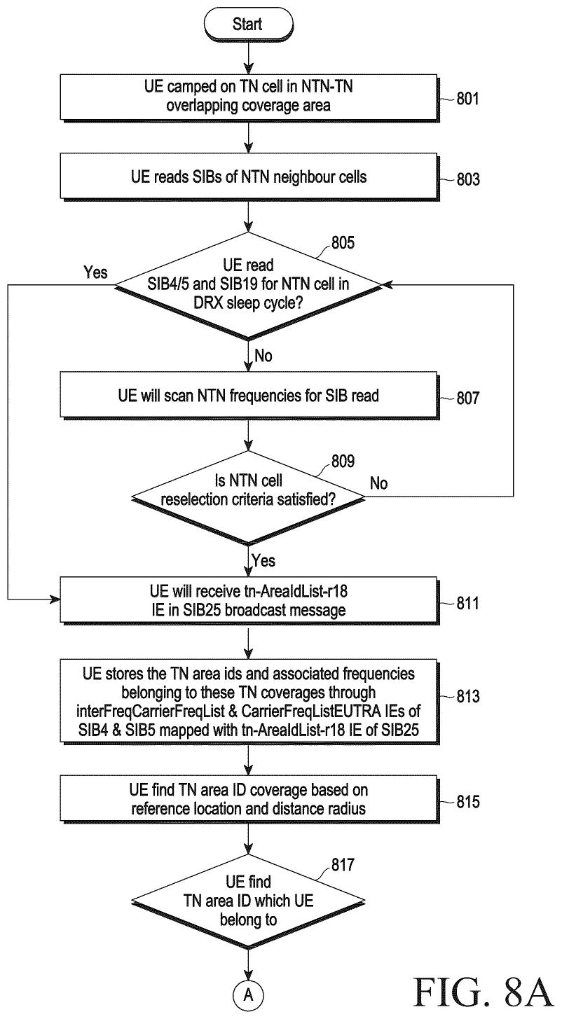

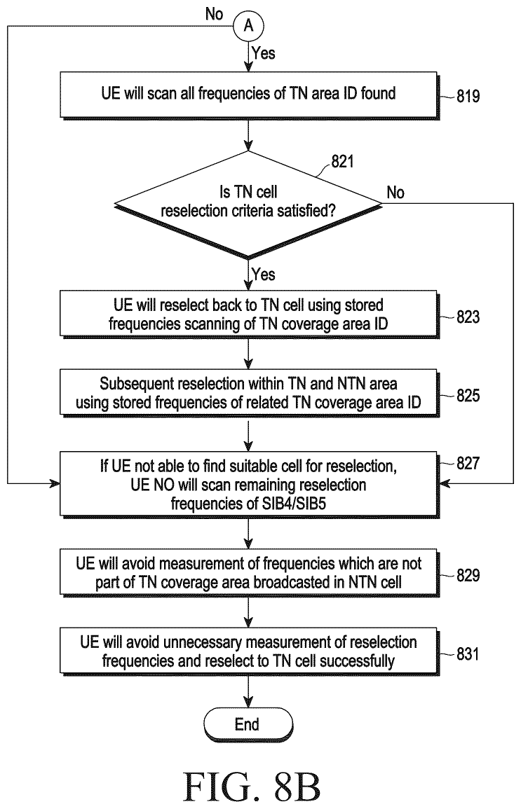

FIGS. 8A and 8B are a flow diagram that illustrates a method for optimizing cell selection in NTN-TN overlapping area in a telecommunication network according to various embodiment of the disclosure.

Referring to FIGS. 8A and 8B, this method is designed to enhance the user experience by ensuring that the UE connects to the most optimal cell, whether it is part of the TN or the NTN. This optimization is needed in areas where both networks overlap, as it helps in maintaining seamless connectivity and improving overall network performance.

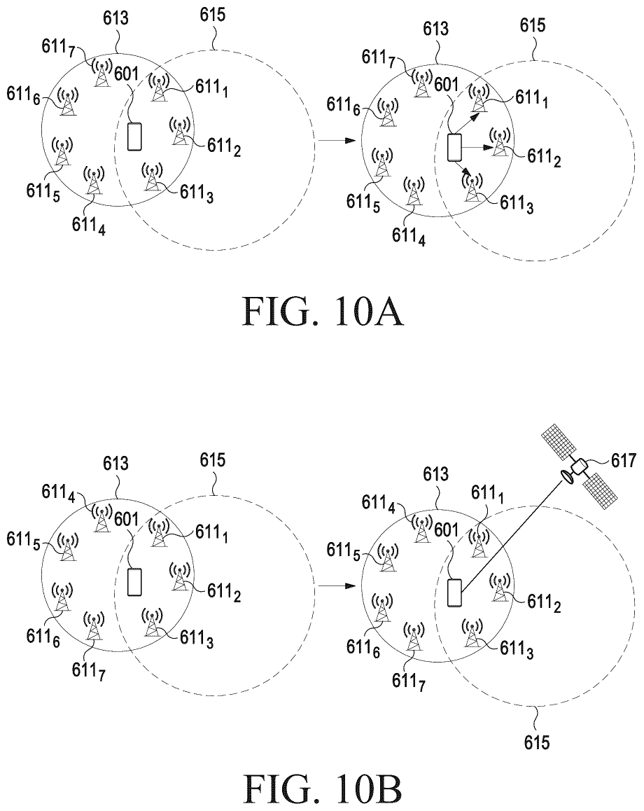

At operation 801, consider the UE 601 is camped on a TN cell in an NTN-TN overlapping coverage area. For example, as shown in FIG. 10A, the UE 601 may be camped on at least one of the TN cells 611₁, 611₂, or 611₃, which are present in the NTN-TN overlapping coverage area. The initial camping on a TN cell allows the UE to establish a baseline connection, ensuring that it has access to network services while it evaluates the surrounding network environment for potential optimization.

At operation 803, the UE 601 detects the presence of NTN coverage based on the reception of SIB4/5 and SIB 19 broadcast messages from the network. These SIBs may include information about the network, including the presence of neighboring cells and their respective characteristics. The UE 601 reads the SIB4/5 and SIB19 broadcast messages to gather information about the NTN cells in the vicinity.

At operation 805, the UE 601 determines whether the NTN neighbor cells are in a Discontinuous Reception (DRX) sleep cycle or if it is momentarily connecting to an NTN cell based on at least one of SIB 19, SIB 4, or SIB 5. The DRX sleep cycle is a power-saving feature that allows the UE to conserve battery life by periodically turning off its receiver. By understanding the DRX status of neighboring NTN cells, the UE may decide whether it is worth attempting a reselection to an NTN cell or if it remains on the current TN cell.

At operation 807, the UE 601 scans the NTN frequencies included in the SIB 19 when the NTN neighbor cells are not in a DRX cycle. This scanning process involves the UE actively searching for NTN cells on the specified frequencies to evaluate their signal strength and quality. If the NTN cells are not in a DRX cycle, they are actively transmitting, making it possible for the UE to assess their suitability for re-selection.

At operation 809, the UE 601 determines whether the cell reselection criteria are satisfied for the NTN neighbor cells. The reselection criteria typically include factors, such as signal strength, signal quality, and the current load on the cell. If the criteria are not satisfied, the UE 601 continues to read SIB 4, SIB 5, and SIB 19 to monitor the network environment and reassess its options periodically. This continuous monitoring ensures that the UE may quickly respond to changes in the network and switch to a more optimal cell if one becomes available.

At operation 811, the UE 601 receives the TN area ID list in the SIB 25 broadcast message when the cell reselection criteria are satisfied for the NTN neighbor cells and when the NTN cell is determined to be in a DRX sleep cycle at operation 805. Additionally, the UE 601 reads SIB25 of the NTN neighbor cell and receives the CoverageAreaInfo-r18 Information Element (IE), which contains TN coverage information details, such as tn-AreaId-r18 (TN coverage area ID), TN coverage area center (TN reference location), and the distance radius of one or more neighbor TN cells. This information is used for the UE to make an informed decision about cell reselection, ensuring that it connects to the optimal cell for maintaining seamless and efficient network connectivity. The structure of the SIB 25 broadcast message is as shown below:

System Information Block 25
ASN1START
TAG-SIB25-START
SIB25-r18 ::= SEQUENCE {
coverageAreaInfoList-r18 CoverageAreaInfoList-r18 OPTIONAL, -

- Need R

lateNonCriticalExtension OCTET STRING OPTIONAL,
...
}
CoverageAreaInfoList-r18 ::= SEQUENCE (SIZE (1..maxTN-AreaInfo-

r18)) OF CoverageAreaInfo-r18

CoverageAreaInfo-r18 ::= SEQUENCE {
tn-AreaId-r18 TN-AreaId-r18,
tn-ReferenceLocation-r18 ReferenceLocation-r17,
tn-DistanceRadius-r18 INTEGER(0..65536)
}
TAG-SIB25-STOP
ASN1STOP

At operation 813, the UE 601 stores the TN area ids and associated frequencies belonging to these TN coverages through ‘interFreqCarrierFreqList” & “CarrierFreqListEUTRA” IEs of SIB4 & SIB5 mapped with “tn-AreaIdList-r18” IE of SIB25. After storing the TN coverage details and TN frequencies, the UE 601 returns to TN cell using stored frequencies scanning as these frequencies associated with the TN coverage area that has high chances of deployment in the area. The structure for the SIB4/SIB5 broadcast message is as shown below:

System Information Block 4
SIB4 ::= SEQUENCE {
interFreqCarrierFreqList InterFreqCarrierFreqList,
InterFreqCarrierFreqInfo-v1800 ::= SEQUENCE {
tn-AreaIdList-r18 SEQUENCE (SIZE (1..maxTN-AreaInfo-r18))

OF TN-AreaId-r18 OPTIONAL -- Need R

}
System Information Block 5
SIB5 ::= SEQUENCE {
CarrierFreqListEUTRA ::= SEQUENCE (SIZE (1..maxEUTRA-

Carrier)) OF CarrierFreqEUTRA

CarrierFreqEUTRA-v1800 ::= SEQUENCE {
tn-AreaIdList-r18 SEQUENCE (SIZE (1..maxTN-AreaInfo-r18))

OF TN-AreaId-r18 OPTIONAL -- Need R

}

At operation 815 and operation 817, the UE 601 determines the tracking network (TN) area ID to which it belongs based on its current location and the center location (reference location) of the TN coverage area as provided by system information block (SIB) 25. This process ensures that the UE 601 is aware of its geographical context within the network, which is used for efficient cell reselection. By leveraging the information from SIB 25, the UE 601 may accurately identify the TN area ID, which serves as a reference for subsequent operations related to cell reselection and network connectivity.

At operation 819, the UE 601 performs neighbor cell measurements for those frequencies that are associated with the TN coverage area. This targeted approach to frequency measurement ensures that the UE 601 is not expending unnecessary resources on frequencies that are irrelevant to its current TN area. By focusing on pertinent frequencies, the UE 601 may streamline the cell reselection process, thereby enhancing its efficiency and reducing the time required to find a suitable cell. This selective measurement strategy also contributes to conserving the UE's battery life, as it minimizes the power consumption associated with scanning extraneous frequencies.

At operation 821, the UE 601 determines whether it may find a suitable cell for cell reselection using the stored frequencies. If a suitable cell is identified, the UE 601 proceeds to operation 823, where it reselects back to the TN cell using these stored frequencies and it subsequently reselect within TN and NTN area using stored frequencies of related TN coverage area ID at operation 825. This ensures that the UE 601 maintains optimal connectivity within the TN coverage area. In cases where the UE 601 cannot find a suitable cell, it moves to operation 827, where it begins scanning the remaining SIB4 and SIB5 frequencies to locate a suitable cell and avoid falling into a no-service condition. This comprehensive scanning process is important when the UE 601 is unable to identify the TN area ID in which it is currently operating, as it helps to maintain continuous service.

The proposed solution at operation 829 ensures that the UE 601 performs measurements for neighbor cells where cell reselection is likely to be successful. This targeted measurement approach not only enhances the reliability of cell reselection but also minimizes the likelihood of the UE 601 engaging in unnecessary measurements.

At operation 831, the UE 601 avoids redundant measurement of neighboring frequencies for cell reselection, which saves power consumption and prevents the “ping-pong” effect between TN cells. This optimization leads to an improved user experience by ensuring more stable connectivity and prolonging the battery performance of the device, especially in areas where TN and NTN coverage overlap. By implementing these strategies, the UE 601 may maintain efficient and reliable network connectivity while conserving energy and enhancing overall device performance.

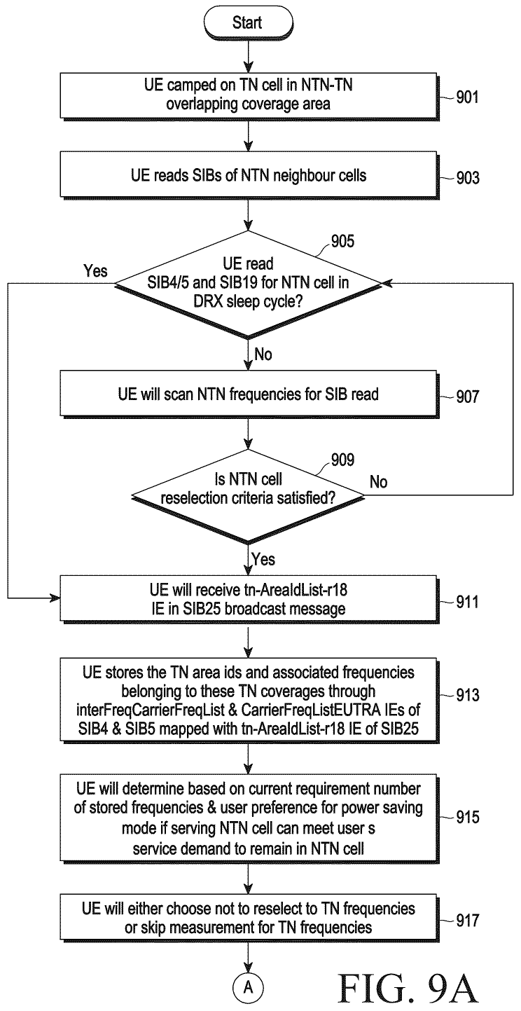

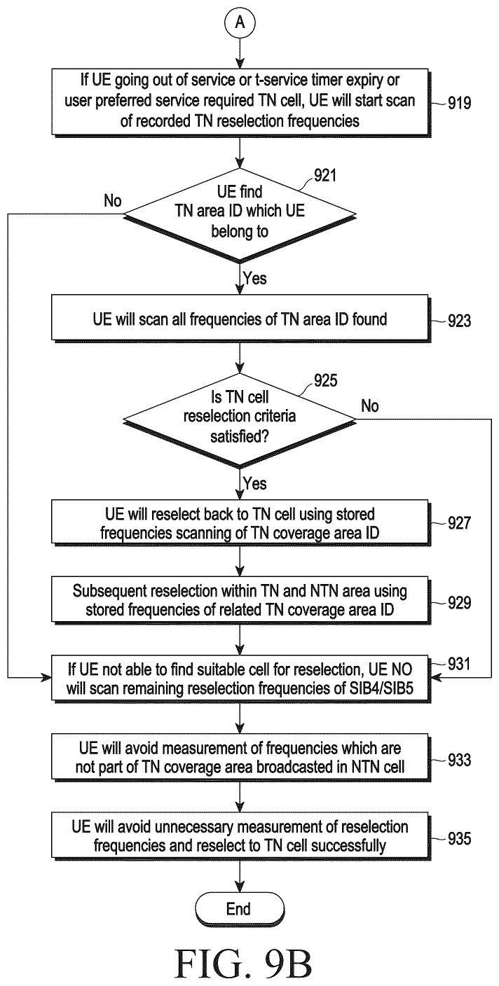

FIGS. 9A and 9B are a flow diagram that illustrates a method for handling cell selection in NTN-TN overlapping area in a telecommunication network according to various embodiments of the disclosure.

Referring to FIGS. 9A and 9B, at operation 901, the UE 601 is camped on a TN-NTN overlapping area. This initial state signifies that the UE is within the coverage area where both TN and Non NTN signals are available, providing a unique scenario for cell selection and reselection processes.

At operation 903, the UE 601 detects that NTN coverage is present using SIB 4/5 and SIB19, which contain information about NTN neighbor cells. This detection allows the UE to recognize the presence of NTN cells and prepare for potential reselection.

At operation 905, once the UE 601 identifies that NTN coverage is present, it determines whether the SIBs of NTN neighbor cells are either in a DRX sleep cycle or if the UE 601 is momentarily camping on an NTN cell. This operation ensures that the UE does not waste resources on cells that are not currently active or relevant.

At operation 907, the UE 601 scan frequencies or perform NTN cell measurements and read the SIB broadcast messages when the NTN cell is not in a DRX sleep cycle. This active scanning allows the UE to gather information about the NTN cells.

Further, at operation 909, the UE 601 determines whether the NTN cell reselection criteria are satisfied. This ensures that the UE reselects to an NTN cell when it meets specific criteria, thereby optimizing network performance and user experience.

At operation 911, the UE 601 reads SIB25 of the NTN neighbor cell and receive the CoverageAreaInfo-r18 information element (IE), which contains TN area information details, such as tn-AreaId-r18, TN coverage area center, and distance radius of one or more neighboring TN areas when the NTN cell reselection criteria are satisfied or when the UE 601 momentarily camps on the NTN cell at operation 905. This information is used for the UE to understand the geographical and coverage context of the TN areas. Further, at operation 913, the UE 601 stores the TN area IDs and associated frequencies belonging to these TN coverages through inter FreqCarrierFreqList & CarrierFreqListEUTRA IEs of SIB4 & SIB5 mapped with tn-AreaIdList-r18 IE of SIB25. This storage allows the UE to have a readily accessible list of TN frequencies and areas for future reselection processes.

At operation 915, after storing the TN coverage details and TN frequencies, the UE 601 determines, based on the current requirement, the number of stored frequencies, and user preference for power-saving mode, if the serving NTN cell may meet the user's service demand and whether to remain in the NTN cell if reselection to multiple TN cells is not required. This decision-making process helps in optimizing power consumption and ensuring that the UE remains connected to the suitable cell.

At operation 917, the UE 601 does not reselect to TN frequencies or skip performing the cell measurements for TN frequencies when the UE 601 has determined to remain in the NTN cell. As the NTN cell cover multiple TN frequency cells, the UE remains on the NTN cell and does not perform TN cell reselection unless necessary to fulfill user demand.

Further, at operation 919, the UE 601 performs cell measurements for stored TN frequencies when the UE 601 is going out of service, when the t-service timer expires, or when the user-preferred services require a TN cell. In case the UE wants to move back to the TN cell, the UE 601 performs neighbor cell measurements for stored frequencies for cell reselection belonging to that TN coverage area ID.

At operation 921, the UE 601 determines the TN area ID to which it belongs. The TN area ID is determined based on the UE's location and the TN reference location of the TN coverage area ID, as these frequencies associated with the TN coverage area that has high chance of deployment in the area.

At operation 923, the UE 601 scan the frequencies associated with the TN area ID when it determines the TN area ID in which it is serving. The frequencies associated with the TN area ID are determined by mapping the TN area ID with the carrier frequency list indicated in the SIB4/SIB5 broadcast message.

Further, at operation 925, the UE 601 determines whether the TN reselection criteria are satisfied while performing the cell measurements of one or more neighboring TN areas.

At operation 927, the UE 601 reselects back to the TN cell using stored frequencies and scanning of the TN coverage area ID. This reselection ensures that the UE connects to the optimal TN cell based on the current network conditions and user requirements.

Further, at operation 929, the UE 601 performs subsequent reselection within the TN and NTN area using stored frequencies of the TN coverage area ID.

At operation 931, the UE 601 starts scanning remaining SIB4 & SIB5 frequencies to find a suitable cell and avoid going to no service when it is not able to find a suitable cell for cell reselection using stored frequencies or when the cell reselection criteria are not satisfied.

At operation 933, the UE 601 avoids measurement of frequencies that are not part of the TN coverage area broadcasted in the NTN cell.

At operation 935, the UE 601 avoids unnecessary measurement of reselection frequencies and reselect to the TN cell successfully. Hence, in the proposed solution, the UE 601 remains in the NTN cell and avoid unnecessary measurement of neighboring frequencies for cell reselection, save power consumption, and avoid ping-pong between NTN-TN cells. In addition, the UE 601 improves the user experience and prolong battery performance of the device in overlapping NTN-TN areas.

FIG. 10A is a schematic diagram that illustrates a scenario of measuring frequencies of neighboring TN cells for cell reselection according to an embodiment of the disclosure.

Referring to FIG. 10A, consider the UE 601 is present in the TN-NTN overlapping area 613, 615. The UE 601 receives the SIB 19 broadcast message from the network indicating the NTN coverage. Further, the UE 601 moves to the NTN cell. Upon moving to the NTN cell, the UE 601 receives a SIB 25 broadcast message and SIB 4/SIB 5 broadcast message from the network apparatus. The SIB 25 broadcast message may include TN area information. The TN area information may include TN coverage area ID of the one or more neighbor TN areas, reference location of the one or more neighbor TN areas, and a distance radius of the one or more neighbor TN areas. For example, the SIB 25 broadcast message may include the TN area information for the TN cells 611₁, 611₂, 611₃, 611₅, 611₆, 611₇. In addition, the SIB 4/SIB 5 broadcast message included the frequency information associated with TN area ID of the at least one neighbor TN cell. For example, the SIB 4/SIB 5 broadcast message may include the frequency information associated with the neighbor TN cells 611₁, 611₂, 611₃, 611₅, 611₆, 611₇.

Further, the UE 601 stores the TN area information received from the SIB 25 and SIB 4/SIB 5 broadcast messages. The UE 601 maps the frequencies associated with TN area ID in the SIB 4/SIB 5 broadcast message. For example, the UE 601 measures the frequencies for the TN cells 611₁, 611₂, 611₃. Hence, the UE 601 in overlapping TN-NTN area measure frequencies associated with TN coverage area to optimize frequency measurements for cell reselection and save unnecessary measurement to reduce power consumption. This selective measurement approach allows the UE 601 to efficiently manage its resources by focusing on relevant TN cells that are within a certain proximity, thereby avoiding the need to measure frequencies from distant or less relevant TN cells. This not only conserves battery life but also enhances the overall performance of the UE 601 by reducing the computational load associated with frequency measurements.

FIG. 10B is a schematic diagram that illustrates a scenario of remaining by UE on NTN cell based on user preference or power saving mode to avoid multiple cell reselection according to an embodiment of the disclosure.

Referring to FIG. 10B, consider the UE 601 is present in the TN-NTN overlapping area 613, 615. The UE 601 receives the SIB 19 broadcast message from the network indicating the NTN coverage. Further, the UE 601 moves to the NTN cell. Upon moving to the NTN cell, the UE 601 receives a SIB 25 broadcast message and SIB 4/SIB 5 broadcast message from the network apparatus. The SIB 25 broadcast message may include TN area information. The TN area information may include TN coverage area ID of the one or more neighbor TN areas, reference location of the one or more neighbor TN areas, and a distance radius of the one or more neighbor TN areas. For example, the SIB 25 broadcast message may include the TN area information for the TN cells 611₁, 611₂, 611₃, 611₅, 611₆, 611₇. In addition, the SIB 4/SIB 5 broadcast message included the frequency information associated with TN area ID of the at least one neighbor TN cell. For example, the SIB 4/SIB 5 broadcast message may include the frequency information associated with the neighbor TN cells 611₁, 611₂, 611₃, 611₅, 611₆, 611₇.

Further, the UE 601 stores the TN area information received from the SIB 25 and SIB 4/SIB 5 broadcast messages. The UE 601 determines whether to remain in the NTN cell based on the current requirement of the UE 601, the number of stored frequencies, user preference for power saving mode, and meeting service demands of the UE 601. For instance, if the UE 601 has a high number of stored frequencies and the user prefers a power-saving mode, the UE 601 may choose to remain in the NTN cell to avoid the energy-intensive process of frequent cell reselection. Additionally, if the service demands of the UE 601 are high, remaining in the NTN cell and receiving network services from the satellite 617 may be more advantageous. This decision-making process allows the UE 601 to balance between maintaining connectivity and conserving power, thereby enhancing the user experience by providing a seamless and efficient network service.

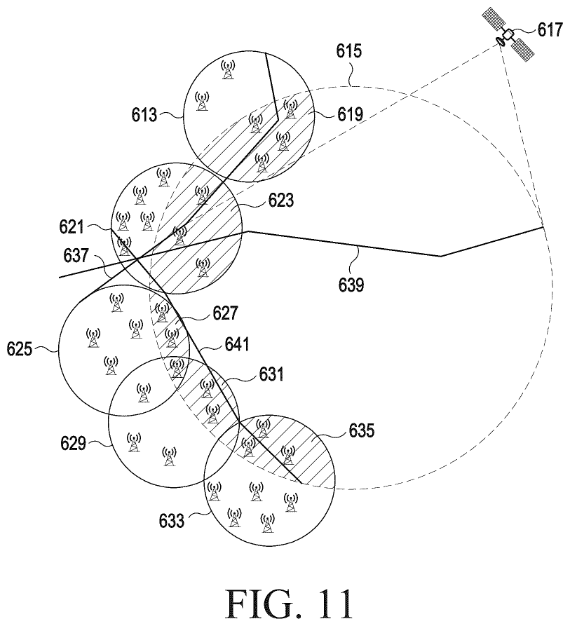

FIG. 11 is a schematic diagram that illustrates a scenario of optimizing by UE to perform cell reselection in a TN-NTN overlapping area while traveling in different paths according to an embodiment of the disclosure.

Referring to FIG. 11, the NTN was introduced to provide coverage in areas where TN cell coverage is not available or deployed. Consider an example where the UE 601 is traveling along path 637 in at least one of the upward directions, crossing the TN areas 613, 621. While the UE 601 is in TN area 621 and when the UE 610 is in the TN-NTN overlapping area 615 and TN area 621, the UE 601 scans the frequencies associated with TN cells present in the overlapping region 623 for accessing network services. Similarly, when the UE 601 is moving upward along path 637 and is present in the TN area 613, the UE 601 scans the frequencies associated with the cells included in the overlapping region 619.

In an embodiment of the disclosure, consider the UE 601 is moving along path 641 towards the downward direction and passing through the TN areas 625, 629, 633. When the UE 601 is passing through the TN area 625, the UE 601 scans the frequencies associated with the cells included in the overlapping region 627. Similarly, when the UE 601 is passing through the TN area 629, the UE 601 scans the frequencies associated with the cells included in the overlapping region 631. Similarly, when the UE 601 is passing through the TN area 633, the UE 601 scans the frequencies associated with the cells included in the overlapping region 635.

In another embodiment of the disclosure, if the UE 601 is traveling along the middle path 639, the UE 601 will either be under NTN cell coverage or requires a large number of TN cell hopping/reselection. In such scenarios, the UE 601 chooses to remain connected to the NTN cell and be served by the satellite 617 based on user preference or various power-saving modes. This approach minimizes the need for frequent cell reselection, thereby conserving the UE's battery life and ensuring a more stable connection. Additionally, the ability to remain connected to the NTN cell while traveling through areas with intermittent TN coverage may provide a seamless user experience, reducing the likelihood of dropped calls or interrupted data sessions.

Furthermore, the optimization process for cell reselection in TN-NTN overlapping areas may be enhanced by incorporating advanced algorithms that take into account the UE's speed, direction, and historical connectivity patterns. These algorithms may predict the most efficient cell reselection strategy, ensuring that the UE 601 maintains optimal connectivity with minimal disruption. For instance, if the UE 601 is detected to be moving at high speeds, the algorithm may prioritize connections to NTN cells to avoid frequent reselection events. Conversely, if the UE 601 is moving slowly or is stationary, the algorithm may favor connections to TN cells to take advantage of potentially higher data rates and lower latency. This dynamic and intelligent approach to cell reselection may significantly improve the overall performance and user satisfaction in TN-NTN overlapping areas.

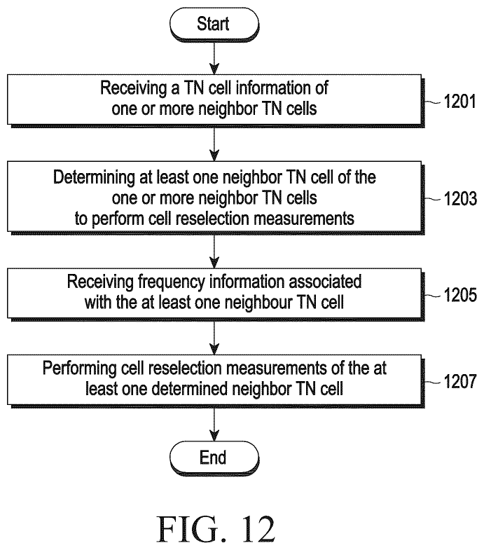

FIG. 12 is a flow diagram that illustrates a method for optimizing cell selection in an NTN-TN overlapping area in a telecommunication network according to an embodiment of the disclosure.

Referring to FIG. 12, this method is particularly useful in scenarios where the UE 601 needs to efficiently switch between the NTN cells and the TN cells to maintain optimal connectivity and service quality.

At operation 1201, the method may include receiving by the UE 601 the TN area information of one or more neighbor TN areas from an NTN cell. The TN area information may include at least one of the TN coverage area ID of the one or more neighbor TN areas, the reference location of the one or more neighbor TN areas, a distance radius of the one or more neighbor TN areas, or the frequency information associated with the TN area ID of the at least one neighbor TN cell. This information allows the UE to have a comprehensive understanding of the surrounding TN cells, which may be used for making informed decisions regarding cell reselection.

In an embodiment of the disclosure, the TN area information of the one or more neighbor TN areas may be stored in the UE. This may ensure that the UE has quick access to the data when it needs to make a decision about cell reselection. By storing this information, the UE may avoid the need to repeatedly request the same data, thereby reducing latency and improving the efficiency of the cell reselection process.

At operation 1203, the method may include determining at least one neighbor TN cell of one or more neighbor TN cells to perform cell reselection measurements based on the TN area information. This determination may help the UE to focus its measurement efforts on the relevant TN cells, thereby optimizing the use of its resources.

At operation 1205, the method may include receiving frequency information associated with the TN area ID of the at least one neighbor TN cell by the UE from the TN cell.

In an embodiment of the disclosure, the UE may determine whether to perform cell reselection measurements based on the TN area information, user preference, and current requirement of the UE. This may involve a decision-making process where the UE evaluates various factors, such as the quality of the current connection, user preferences for types of networks, and the specific requirements of the applications currently in use. This ensures that the cell reselection process is aligned with the user's needs and the operational context of the UE.

At operation 1207, the method may include performing cell reselection measurements of the at least one determined neighbor TN cell. This involves the UE actively measuring the signal strength and quality of the identified TN cells to determine if a better connection may be established.

In an embodiment of the disclosure, the UE may skip the performance of cell reselection measurements of the one or more neighbor TN cells. This may be taken if the UE determines that the current connection is satisfactory or if the potential benefits of switching to a different cell do not outweigh the costs. By skipping unnecessary measurements, the UE may conserve its resources and maintain a stable connection.

The various actions, acts, blocks, steps, operations, or the like in the method is performed in the order presented, in a different order or simultaneously. Further, in some embodiments, some of the actions, acts, blocks, steps, operations, or the like are omitted, added, modified, skipped, or the like without departing from the scope of the proposed method.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for cell selection/reselection in a non-terrestrial network (NTN)-terrestrial network (TN) overlapping coverage area in a communication network, the method comprising:
obtaining, by a user equipment (UE) from an NTN cell, TN area information of one or more neighbor TN areas;
obtaining, by the UE from at least one TN cell, frequency information based on the obtained TN area information;
determining, by the UE, at least one neighbor TN cell to perform cell selection/reselection measurements based on the obtained frequency information; and
performing, by the UE, cell selection/reselection measurements of the at least one determined neighbor TN cell.

2. The method of claim 1, wherein the obtaining, by the UE from the NTN cell, of the TN area information of the one or more neighbor TN areas comprises:
camping, by the UE, on a TN cell in the NTN-TN overlapping coverage area;
obtaining, by the UE from the TN cell, information about the NTN cell in the NTN-TN overlapping coverage area;
connecting, by the UE, to the NTN cell based on the obtained information about the NTN cell;
receiving, by the UE from the NTN cell, the TN area information of the one or more neighbor TN areas via a first system information block (SIB); and
returning, by the UE, to the TN cell.

3. The method of claim 1, wherein the TN area information of one or more neighbor TN areas comprises a TN area identifier (ID) of the one or more neighbor TN areas, a reference location of the one or more neighbor TN areas, and a distance radius of the one or more neighbor TN areas.

4. The method of claim 1,
wherein the frequency information comprises neighbor frequency information associated with a TN area identifier (ID) of the one or more neighbor TN areas, and
wherein the frequency information is received via a second system information block (SIB) or a third SIB.

5. The method of claim 4, wherein the frequency information is interFreqCarrierFreqList in the second SIB or CarrierFreqListEUTRA in the third SIB.

6. The method of claim 2, wherein the information about the NTN cell is obtained via a fourth SIB.

7. The method of claim 3, wherein the determining, by the UE, of the at least one neighbor TN cell to perform the cell selection/reselection measurements based on the obtained frequency information comprises:
determining, by the UE, current location of the UE;
determining, by the UE, the TN area ID to perform cell selection/reselection measurements based on the current location of the UE, the reference location of the one or more neighbor TN areas, and the distance radius of the one or more neighbor TN areas;
determining, by the UE, frequency associated with the TN area ID; and
determining, by the UE, the at least one neighbor TN cell to perform the cell selection/reselection measurements based on the frequency.

8. The method of claim 1, wherein the performing, by the UE, of the cell selection/reselection measurements of at least one determined neighbor TN cell comprises:
measuring, by the UE, frequencies of the at least one determined neighbor TN cell;
determining, by the UE, whether TN cell reselection criteria of the at least one determined neighbor TN cell is satisfied; and
reselecting, by the UE, a TN neighbor cell among the at least one determined neighbor TN cell for which the TN cell reselection criteria is satisfied.

9. The method of claim 1, further comprising:
determining, by the UE, whether to perform the cell selection/reselection measurements based on user preference; and
skip performing, by the UE, the cell selection/reselection measurements of the one or more neighbor TN cells based on the user preference being set as a power saving mode.

10. A user equipment (UE) for handling cell selection/reselection in a non-terrestrial network (NTN)-terrestrial network (TN) overlapping coverage area in a communication network comprises:
memory, comprising one or more storage media, storing instructions; and
at least one processor communicatively coupled to the memory,
wherein the instructions, when executed by the at least one processor individually or collectively, cause the UE to:
obtain TN area information of one or more neighbor TN areas from an NTN cell,
obtain frequency information based on the obtained TN area information,
determine at least one neighbor TN cell to perform cell selection/reselection measurements based on the obtained frequency information, and
perform cell selection/reselection measurements of the at least one determined neighbor TN cell.

11. The UE of claim 10, wherein, to obtain the TN area information of the one or more neighbor TN areas, the instructions, when executed by the at least one processor individually or collectively, further cause the UE to:
camp on a TN cell in the NTN-TN overlapping coverage area,
obtain information about the NTN cell in the NTN-TN overlapping coverage area from the TN cell,
connect to the NTN cell based on the obtained information about the NTN cell,
receive the TN area information of the one or more neighbor TN areas via a first system information block (SIB), and
return to the TN cell.

12. The UE of claim 11, wherein the TN area information of one or more neighbor TN areas comprises a TN area identifier (ID) of the one or more neighbor TN areas, a reference location of the one or more neighbor TN areas, and a distance radius of the one or more neighbor TN areas.

13. The UE of claim 12,
wherein the frequency information comprises neighbor frequency information associated with the TN area ID of the one or more neighbor TN areas, and
wherein the frequency information is received via a second system information block (SIB) or a third SIB.

14. The UE of claim 13, wherein the frequency information is interFreqCarrierFreqList in the second SIB or CarrierFreqListEUTRA in the third SIB.

15. The UE of claim 12, wherein the information about the NTN cell is obtained via a fourth SIB.

16. The UE of claim 12, wherein to determine the at least one neighbor TN cell to perform the cell selection/reselection measurements based on the obtained frequency information, the instructions, when executed by the at least one processor individually or collectively, further cause the UE to:
determine current location of the UE,
determine a TN area ID to perform cell selection/reselection measurements based on the current location of the UE, the reference location of the one or more neighbor TN areas, and the distance radius of the one or more neighbor TN areas,
determine frequency associated with the TN area ID, and
determine the at least one neighbor TN cell to perform the cell selection/reselection measurements based on the frequency.

17. The UE of claim 10, wherein to perform the cell selection/reselection measurements of at least one determined neighbor TN cell, the instructions, when executed by the at least one processor individually or collectively, further cause the UE to:
measure frequencies of the at least one determined neighbor TN cell,
determine whether TN cell reselection criteria of the at least one determined neighbor TN cell is satisfied, and
reselect a TN neighbor cell among the at least one determined neighbor TN cell for which the TN cell reselection criteria is satisfied.

18. The UE of claim 10, wherein the instructions, when executed by the at least one processor individually or collectively, further cause the UE to:
determine whether to perform the cell selection/reselection measurements based on user preference, and
skip performing the cell selection/reselection measurements of the one or more neighbor TN cells based on the user preference being set as a power saving mode.

19. One or more non-transitory computer-readable storage media storing one or more computer programs including computer-executable instructions that, when executed by at least one processor individually or collectively, cause a user equipment (UE) to perform operations, the operations comprising:
obtaining terrestrial network (TN) area information of one or more neighbor TN areas from a non-terrestrial network (NTN) cell;
obtaining frequency information based on the obtained TN area information from at least one TN cell;
determining at least one neighbor TN cell to perform cell selection/reselection measurements based on the obtained frequency information; and
performing cell selection/reselection measurements of the at least one determined neighbor TN cell.

20. The one or more non-transitory computer-readable storage media of claim 19, wherein the obtaining, by the UE from the NTN cell, of the TN area information of the one or more neighbor TN areas comprises:
camping, by the UE, on a TN cell in the NTN-TN overlapping coverage area;
obtaining, by the UE from the TN cell, information about the NTN cell in the NTN-TN overlapping coverage area;
connecting, by the UE, to the NTN cell based on the obtained information about the NTN cell;
receiving, by the UE from the NTN cell, the TN area information of the one or more neighbor TN areas via a first system information block (SIB); and
returning, by the UE, to the TN cell.
